(19) United States
(12) Patent Application Publication
(10) Pub. No.: US 2023/0394321 A1
(43) Pub. Date: Dec. 7, 2023

(54) SERVER APPARATUS

(71) Applicant: NEC Corporation, Tokyo (JP)

(72) Inventor: Junki Mori, Tokyo (JP)

(73) Assignee: NEC Corporation, Tokyo (JP)

(21) Appl. No.: 18/203,950

(22) Filed: May 31, 2023

(30) Foreign Application Priority Data
Jun. 7, 2022 (JP) 2022-092301

(51) Int. Cl. G06N 3/098

(52) U.S. Cl. CPC G06N 3/098

(57) ABSTRACT

A server apparatus includes: a receiving unit configured to receive, from each of a plurality of client apparatuses performing federated learning of a neural network model having multiplex branches capable of performing different operations on a common input, a local model parameter of each of the multiplex branches and a weight for each branch used in superposing outputs from the respective multiplex branches; a calculating unit configured to calculate a parameter of a global model based on the local model parameter and the weight received by the receiving unit; and a transmitting unit configured to transmit the parameter calculated by the calculating unit to the client apparatuses.

### INCORPORATION BY REFERENCE

This application is based upon and claims the benefit of priority from Japanese patent application No. 2022-092301, Jun. 7, 2022, the disclosure of which is incorporated herein in its entirety by reference.

### TECHNICAL FIELD

The present invention relates to a server apparatus, a calculation method, and a client apparatus.

### BACKGROUND ART

From the viewpoint of privacy protection and the like, a technique called federated learning is known in which a plurality of clients cooperate to perform machine learning without directly exchanging training data.

A literature describing federated learning is, for example, Patent Literature 1. Patent Literature 1 describes a machine learning system that includes a plurality of client terminals and an integrated server. According to Patent Literature 1, the client terminal executes machine learning of a training target local model by using data existing in the system to which the client terminal belongs as training data in accordance with an instruction of received distribution information. The client terminal then transmits the result of learning of the local model to the integrated server. The integrated server transmits distribution information to the respective client terminals, receives the learning results from the respective client terminals, and integrates the received learning results to update a master model.

Further, although an averaged model is obtained in general federated learning, a technique called personalized federated learning is known as a federated learning approach of obtaining not an averaged model but a model optimized for each client.

A literature describing personalized federated learning is, for example, Non-Patent Literature 1. For example, Non-Patent Literature 1 describes a method in which a client receives local models from other clients, gives a large weight to a local model that fits data of the client to add to a local model of the client, and thereby updates the local model.

Patent Literature 1: WO2021/193815

Non-Patent Literature 1: Zhang, Michael, et al. “Personalized Federated Learning with First Order Model Optimization.”, ICLR2021

In the technique described by Non-Patent Literature 1, a client needs to obtain local models of other clients, and the local models are shared among all the clients. Therefore, the risk of information leakage is high. Thus, there is a problem that it is difficult to obtain a model appropriate for each client while suppressing the risk of information leakage.

### SUMMARY OF THE INVENTION

Accordingly, an object of the present invention is to provide a server apparatus, a calculation method and a client apparatus that solve the abovementioned problem.

In order to achieve the object, a server apparatus as an aspect of the present disclosure includes: at least one memory configured to store instructions; and at least one processor configured to execute the instructions. The processor is configured to: receive, from each of a plurality of client apparatuses performing federated learning of a neural network model having multiplex branches capable of performing different operations on a common input, a local model parameter of each of the multiplex branches and a weight for each branch used in superposing outputs from the respective multiplex branches; calculate a parameter of a global model based on the local model parameter and the weight received by the receiving unit; and transmit the parameter calculated by the calculating unit to the client apparatuses.

Further, a calculation method as another aspect of the present disclosure is a calculation method by an information processing apparatus, and includes: receiving, from each of a plurality of client apparatuses performing federated learning of a neural network model having multiplex branches capable of performing different operations on a common input, a local model parameter of each of the multiplex branches and a weight for each branch used in superposing outputs from the respective multiplex branches; calculating a parameter of a global model based on the received local model parameter and weight; and transmitting the calculated parameter to the client apparatuses.

Further, a client apparatus as another aspect of the present disclosure includes: at least one memory configured to store instructions; and at least one processor configured to execute the instructions. The processor is configured to: learn, using training data owned by the client apparatus, a local model parameter of each of multiplex branches included by a neural network model having the multiplex branches capable of performing different operations on a common input and a weight for each branch used in superposing outputs from the respective multiplex branches; and transmit the local model parameter and the weight learned by the learning unit to a server apparatus that generates a global model based on the local model parameter.

With the respective configurations as described above, the abovementioned problem can be solved.

### BRIEF DESCRIPTION OF DRAWINGS

FIG. 1 is a view showing an example of a general neural network;

FIG. 2 is a view showing an example of a configuration when a linear transformation of a neural network is multiplexed;

FIG. 3 is a view showing an example of a configuration of a learning system according to the first example embodiment of the present disclosure;

FIG. 4 is a block diagram showing an example of a configuration of a client apparatus;

FIG. 5 is a view for describing an example of processing by a learning unit;

FIG. 6 is a block diagram showing an example of a configuration of a server apparatus;

FIG. 7 is a view for describing an example of processing by a calculating unit;

FIG. 8 is a flowchart showing an example of operation of the client apparatus;

FIG. 9 is a flowchart showing an example of operation of the server apparatus;

FIG. 10 is a view for describing an example of an effect of the server apparatus;

FIG. 11 is a hardware diagram showing an example of a configuration of a server apparatus in a second example embodiment of the present disclosure;

FIG. 12 is a block diagram showing an example of a configuration of a server apparatus; and

FIG. 13 is a block diagram showing an example of a configuration of a client apparatus.

### EXAMPLE EMBODIMENT

### First Example Embodiment

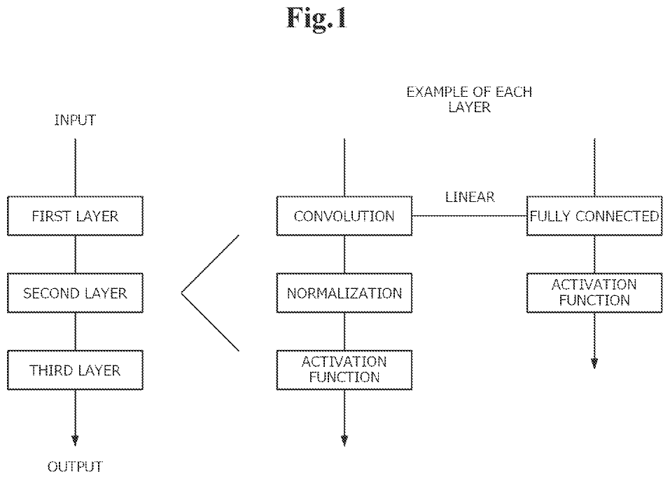

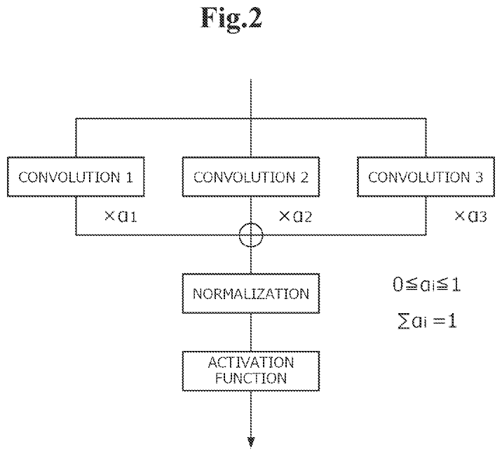

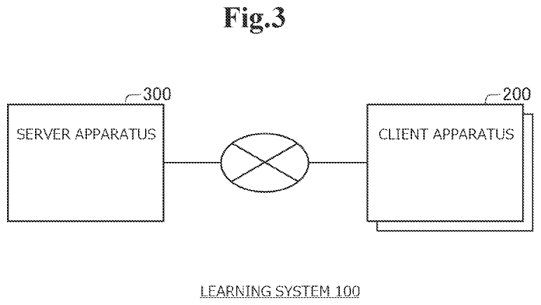

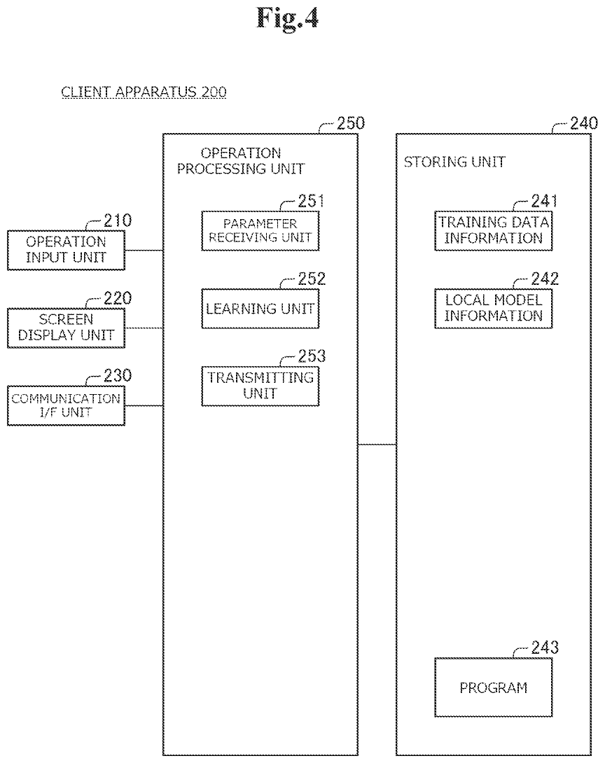

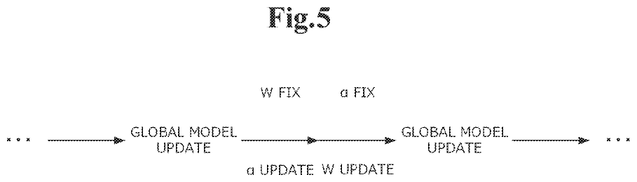

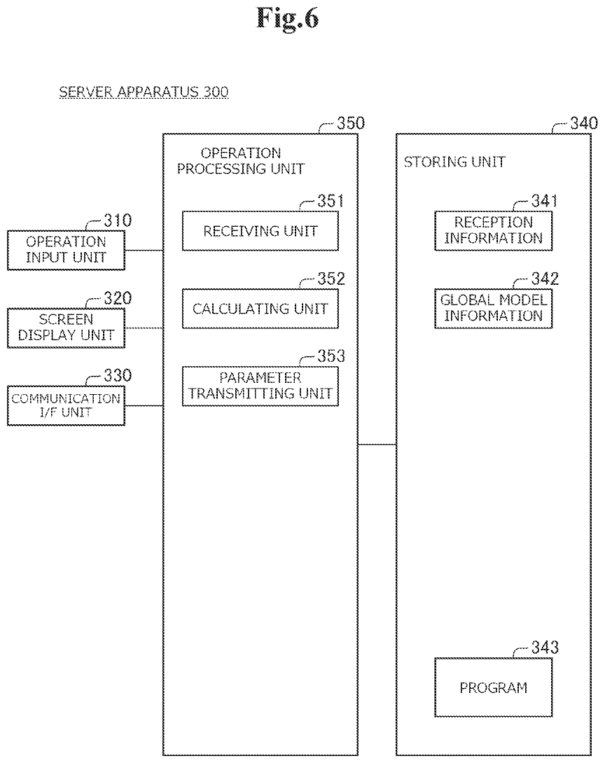

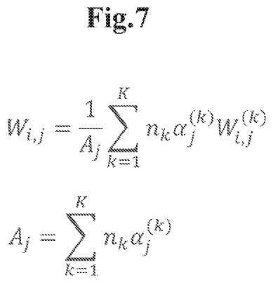

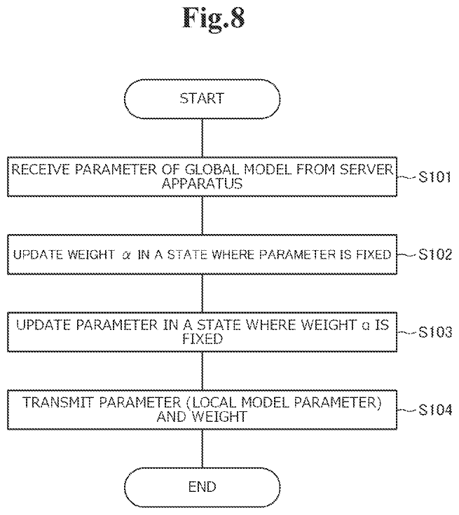

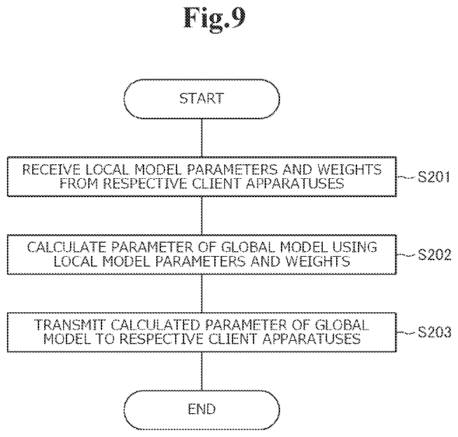

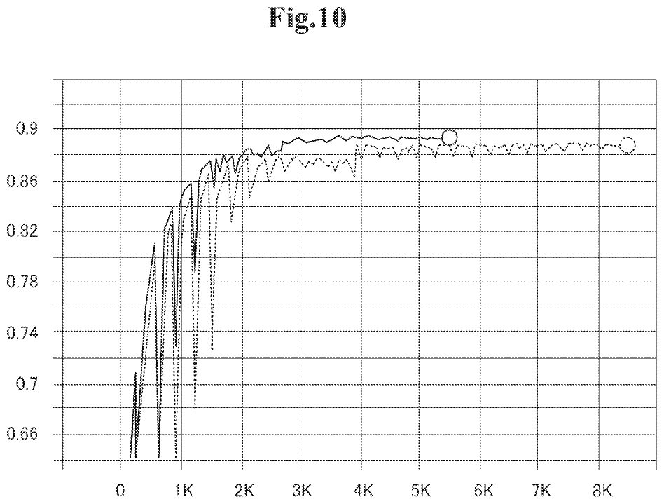

A first example embodiment of the present disclosure will be described with reference to FIGS. 1 to 10. FIG. 1 is a view showing an example of a general neural network. FIG. 2 is a view showing an example of a configuration when a linear transformation of a neural network is multiplexed. FIG. 3 is a view showing an example of a configuration of a learning system 100. FIG. 4 is a block diagram showing an example of a configuration of a client apparatus 200. FIG. 5 is a view for describing an example of processing by a learning unit 252. FIG. 6 is a block diagram showing an example of a configuration of a server apparatus 300. FIG. 7 is a view for describing an example of processing by a calculating unit 352. FIG. 8 is a flowchart showing an example of operation of the client apparatus 200. FIG. 9 is a flowchart showing an example of operation of the server apparatus 300. FIG. 10 is a view for describing an example of an effect of the server apparatus.

In the first example embodiment of the present disclosure, a learning system 100 that performs federated learning in which a plurality of client apparatuses 200 and a server apparatus 300 learn in cooperation will be described. As illustrated in FIG. 1, a machine learning model learned by the learning system 100 in this example embodiment is a neural network including a plurality of layers composed of a linear transformation and a nonlinear transformation. A neural network includes a layer that includes a convolutional layer performing convolution operation, a normalization layer performing a normalization process such as scale conversion and an activation layer using an activation function such as ReLU (Rectified Linear Unit), a layer that includes a fully connected layer and an activation layer, and the like. For example, in the case illustrated in FIG. 1, linear transformation is performed in the convolutional layer, the fully connected layer and the like, and nonlinear transformation is performed in the activation layer and the like. A neural network may have a structure such that all layers include convolutional layers, normalization layers and activation layers, or may have a plurality of structures such as both a layer including a convolutional layer and an normalization layer and a layer including a fully connected layer and an activation layer. Moreover, the structure of a neural network is not limited to the case illustrated in FIG. 1, and may have a fourth layer or higher, for example.

Further, in the case of this example embodiment, in the machine learning model learned by the learning system 100, a linear transformation can be multiplexed. For example, as illustrated in FIG. 2, the neural network described in this example embodiment has multiplex branches that can perform different operations on a common input. For example, FIG. 2 illustrates a case where a certain layer configuring the neural network has three branches and each of the branches performs a convolutional operation. In other words, in the case illustrated by FIG. 2, a certain layer of the neural network has a branch to perform a convolution operation 1, a branch to perform a convolution operation 2 and a branch to perform a convolution operation 3, and the respective branches receive a common input. The number of branches included by one layer may be a number other than illustrated above, such as two or four or more. Each branch may perform linear transformation other than a convolutional operation, such as a fully connected operation. In the multiplex branches that receive a common input, all the branches may perform the same operation, such as a convolutional operation, or the respective branches may perform different operations, for example, some of the branches may perform a fully connected operation. Some of the branches may perform any operation other than linear transformation.

Further, in the case of this example embodiment, in the machine learning model learned by the learning system 100, outputs from the respective multiplex branches are superposed using weights for the respective branches. For example, in the machine learning model, by calculating a weighted sum that is adding the results of multiplying the outputs from the branches by weights corresponding to the branches, the outputs from the respective branches are superposed using the weights for the respective branches. For example, in the case illustrated in FIG. 2, the result of multiplying the output from a branch to perform a convolution operation 1 by weight α1 corresponding to the branch, the result of multiplying the output from a branch to perform a convolution operation 2 by weight α2 corresponding to the branch, and the result of multiplying the output from a branch to perform a convolution operation 3 by weight α3 corresponding to the branch are added. The weight is a value equal to or more than 0 and equal to or less than 1, for example. The weights corresponding to the respective branches in the same layer have a relation to be 1 when added together.

The respective branches perform a common operation using parameters common in each client apparatus 200. In other words, the parameters of the respective branches are learned by federated learning by the client apparatuses 200 and the server apparatus 300. On the other hand, a weight for each branch used in superposing the outputs from the respective multiplex branches, a normalization parameter used in a normalization layer, and the like, are learned by each client apparatus 200. Therefore, the weight, the normalization parameter, and the like, may vary for each client apparatus 200. By learning the weight and the like for each client apparatus 200, each client apparatus 200 can learn a local model appropriate for its own data.

FIG. 3 shows an example of a configuration of the learning system 100. Referring to FIG. 3, for example, the learning system 100 has the plurality of client apparatuses 200 and the server apparatus 300. As shown in FIG. 3, the client apparatuses 200 and the server apparatus 300 are connected so as to be able to communicate with each other via a network, for example. The learning system 100 may have any number of client apparatuses 200, which is equal to or more than 2.

The client apparatus 200 is an information processing apparatus that updates a parameter and the like received from the server apparatus 300 by using training data of the client apparatus 200. FIG. 4 shows an example of a configuration of the client apparatus 200. Referring to FIG. 4, the client apparatus 200 has, as major components, an operation input unit 210, a screen display unit 220, a communication I/F (interface) unit 230, a storing unit 240, and an operation processing unit 250, for example.

FIG. 4 illustrates a case of realizing a function as the client apparatus 200 by using one information processing apparatus. However, the client apparatus 200 may be realized by using a plurality of information processing apparatuses, for example, realized on the cloud. Moreover, the client apparatus 200 may not include part of the above configuration, for example, without the operation input unit 210 and the screen display unit 220, or may have a configuration other than the configuration illustrated above.

The operation input unit 210 is formed of an operation input device such as a keyboard and a mouse. The operation input unit 210 detects an operation by an operator who operates the client apparatus 200 and outputs to the operation processing unit 250.

The screen display unit 220 is formed of a screen display device such as an LCD (Liquid Crystal Display). The screen display unit 220 can display on a screen a variety of information stored in the storing unit 240 in accordance with an instruction from the operation processing unit 250.

The communication I/F unit 230 is formed of a data communication circuit and the like. The communication I/F unit 230 performs data communication with an external apparatus such as the server apparatus 300 connected via a communication line.

The storing unit 240 is a storage device such as a HDD (hard disk drive), a SSD (Solid State Drive), and memory. The storing unit 240 stores therein processing information necessary for a variety of processing by the operation processing unit 250 and a program 243. The program 243 is loaded and executed by the operation processing unit 250 to realize various processing units. The program 243 is loaded in advance from an external device and a recording medium via a data input/output function such as the communication I/F unit 230 and is stored in the storing unit 240. Major information stored in the storing unit 240 includes training data information 241, local model information 242, and the like.

The training data information 241 includes training data used when the learning unit 252 to be described later performs learning. For example, the training data information 241 is acquired in advance by a method such as acquiring from an external device via the communication I/F unit 230 or inputting with the operation input unit 210 and the like, and is stored in the storing unit 240. For example, the training data included by the training data information 241 may vary for each client apparatus 200. In this example embodiment, a specific content of the training data is not particularly limited. The training data information 241 may include any training data.

The local model information 242 includes information indicating various parameters and values configuring a local model, such as a parameter used in an operation corresponding to each branch (for example, a local model parameter), a weight for each branch used in superposing the outputs from the respective branches, and a normalization parameter. For example, the local model information 242 is updated in accordance with various processes such as reception of the parameters of the respective branches from the server apparatus 300 and learning with the training data information 241 by a learning unit 252 to be described later.

The operation processing unit 250 has an arithmetic logic unit such as a CPU (Central Processing Unit) and a peripheral circuit thereof. By loading the program 243 from the storing unit 243 and executing the program 243, the operation processing unit 250 makes the abovementioned hardware and the program 243 cooperate and realizes various processing units. Major processing units realized by the operation processing unit 250 include a parameter receiving unit 251, a learning unit 252, a transmitting unit 253, and the like.

The operation processing unit 250 may have, instead of the abovementioned CPU, a GPU (Graphic Processing Unit), a DSP (Digital Signal Processor), a MPU (Micro Processing Unit), a FPU (Floating point number Processing Unit), a PPU (Physics Processing Unit), a TPU (Tensor Processing Unit), a quantum processor, a microcontroller, or a combination thereof.

The parameter receiving unit 251 receives a parameter corresponding to each of the branches in each of the layers configuring the training target neural network, from the server apparatus 300. For example, the parameter receiving unit 251 receives weight values used in performing an operation such as a convolution operation as parameters. Moreover, the parameter receiving unit 251 stores the received parameters as the local model information into the storing unit 240.

The learning unit 252 performs machine learning using the training data included by the training data information 241 on a model having the parameter received by the parameter receiving unit 251, and thereby updates a parameter of each branch, a weight for each branch, and the like. In other words, the learning unit 252 performs machine learning using the training data included by the training data information 241 and updates the parameter, the weight and the like for each branch, and thereby generates a local model having a new local model parameter. For example, the learning unit 252 can update, for each of the layers configuring the neural network, a parameter for each branch, a weight for each branch, and the like. In other words, the parameters of the respective branches and the weights for the respective branches may vary for each layer. Other than the parameters for the respective branches, the weights for the respective branches, and the like, the learning unit 252 may learn a normalization parameter, and the like. For example, the learning unit 252 may perform the abovementioned machine learning using a known method such as stochastic gradient descent.

For example, the learning unit 252 performs the machine learning using the training data, and thereby updates the parameter received by the parameter receiving unit 251 and calculates a new local model parameter. That is to say, a target parameter for update by the learning unit 252 is a value received by the parameter receiving unit 251, and is common in each client apparatus 200. On the other hand, the learning unit 252 performs the machine learning using the training data, and thereby updates the weight calculated in previous local model parameter calculation and calculates a new weight. That is to say, a target weight for update by the learning unit 252 is a value calculated before by each client apparatus 200, and can vary for each client apparatus 200.

The learning unit 252 can separate a phase of learning a parameter of each branch and a phase of learning a weight corresponding to each branch as illustrated in FIG. 5. For example, the learning unit 252 can update a weight α in a state where a parameter of each branch is fixed, and thereafter update the parameter of each branch using the updated weight α in a state where the weight α is fixed. By first determining the optimum weight α and then updating the parameter, it is possible to appropriately evaluate the degree of update of the parameter in each client apparatus 200.

The transmitting unit 253 transmits a local model parameter, which is the parameter updated by the learning unit 252, and the weight for each branch to the server apparatus 300. In other words, the transmitting unit 253 in this example embodiment transmits not only the local model parameter but also the weight corresponding to each branch to the server apparatus 300.

The above is an example of the configuration of the client apparatus 200. Meanwhile, the configuration of the client apparatus 200 is not limited to the case illustrated above. For example, the operation processing unit 250 of the client apparatus 200 may execute the program 243 and thereby realize a converting unit that converts a plurality of branches to one branch by using the parameters of the respective branches and the weights corresponding to the respective branches. Moreover, the operation processing unit 250 of the client apparatus 200 may execute the program 243 and thereby realize an interring unit that performs inference using a local model determined in accordance with the parameter (local model parameter), the weight, and the like, indicated by the local model information 242. For example, as described above, the client apparatus 200 may have a configuration other than illustrated above.

The server apparatus 300 is an information processing apparatus that calculates the parameter of a global model by using the local model parameters and the weights received from the respective client apparatuses 200. FIG. 6 shows an example of a configuration of the server apparatus 300. Referring to FIG. 6, the server apparatus 300 has, as major components, an operation input unit 310, a screen display unit 320, a communication I/F unit 330, a storing unit 340, and an operation processing unit, for example.

FIG. 6 illustrates a case of realizing a function as the server apparatus 300 by using one information processing apparatus. However, the server apparatus 300 may be realized by using a plurality of information processing apparatuses, for example, may be realized on the cloud. Moreover, the server apparatus 300 may not include part of the configuration illustrated above, for example, may not have the operation input unit 310 and the screen display unit 320, or may have a configuration other than illustrated above.

The operation input unit 310 is formed of an operation input device such as a keyboard and a mouse. The operation input unit 310 detects operation of an operator who operates the server apparatus 300, and outputs the operation to the operation processing unit 350.

The screen display unit 320 is formed of a screen display device such as an LCD. The screen display unit 320 can display on a screen a variety of information stored in the storing unit 340 in accordance with an instruction from the operation processing unit 350.

The communication I/F unit 330 is formed of a data communication circuit, and the like. The communication I/F unit 330 performs data communication with an external apparatus such as the client device 200 connected via a communication line.

The storing unit 340 is a storage device such as a HDD, a SSD, and memory. The storing unit 340 stores therein processing information necessary for a variety of processing by the operation processing unit 350 and a program 343. The program 343 is loaded and executed by the operation processing unit 350 and thereby realizes various processing units. The program 343 is loaded in advance from an external device and a recording medium via a data input/output function such as the communication I/F unit 330 and is stored in the storing unit 340. Major information stored in the storing unit 340 includes, for example, reception information 341 and global model information 342.

The reception information 341 includes information indicating local model parameters and weights received from the respective client apparatuses 200. For example, the reception information 341 is updated when a receiving unit 351 receives information indicating local model parameters and weights from the client apparatuses 200 via the communication I/F unit 330.

The global model information 342 includes information indicating a model parameter of a global model, calculated based on the reception information 341. For example, the global model information 342 is updated when a calculating unit 352 to be described later calculates a parameter based on the reception information 341.

In the storing unit 340, information other than illustrated above may be stored. For example, information indicating the number of training data owned by each of the client apparatuses 200 included by the learning system 100 can be stored in the storing unit 340.

The operation processing unit 350 has an arithmetic logic unit such as a CPU and a peripheral circuit thereof. The operation processing unit 350 loads the program 343 from the storing unit 340 and executes the program 343, and thereby makes the abovementioned hardware and the program 343 cooperate and realizes various processing units. Major processing units realized by the operation processing unit 350 includes, for example, the receiving unit 351, the calculating unit 352, and a parameter transmitting unit 353. As in the case of the operation processing unit 250 included by the client apparatus 200, the operation processing unit 350 may have, instead of the CPU, a GPU or the like.

The receiving unit 351 receives a local model parameter of each branch and a weight corresponding to each branch from each client apparatus 200. Moreover, the receiving unit 351 stores the received local model parameter and weight as the reception information 341 into the storing unit 340.

The calculating unit 352 uses the local model parameter and the weight received by the receiving unit 351 to calculate and update the parameter of the global model for each branch for each layer configuring the neural network. For example, the calculating unit 352 calculates the parameter of the global model by performing weighting with the weights and taking the average of the local model parameters. The calculating unit 352 may calculate the parameter of the global model by using the local model parameters, the weights, the number of the training data owned by the client apparatus 200, and the like.

For example, as shown in FIG. 7, the calculating unit 352 solves an equation indicated by Equation 1 to thereby calculate the parameter of the global model based on the number of data, the local model parameter, and the weight,

$${W}_{i , j} = \frac{1}{{A}_{j}} {\sum }_{k = 1}^{K} {n}_{k} {α}_{j}^{( k )} {W}_{i , j}^{( k )} \qquad [ Equation 1 ]$$

$${A}_{j} = {\sum }_{k = 1}^{K} {n}_{k} {α}_{j}^{( k )}$$

where n denotes the number of data owned by the corresponding client apparatus 200, k denotes an identifier for identifying the client apparatus 200, K denotes the number of the client apparatuses 200 included by the learning system 100, W_{i,j} denotes the parameter of a j^{th} branch of an i^{th} layer, and a denotes a weight.

The parameter transmitting unit 353 transmits the parameter of the global model calculated by the calculating unit 352 to the client apparatus 200.

The above is an example of the configuration of the server apparatus 300. Subsequently, an example of operation of the learning system 100 will be described with reference to FIGS. 8 and 9. First, with reference to FIG. 8, an example of operation of the client apparatus 200 will be described.

FIG. 8 is a flowchart showing an example of operation of the client apparatus 200. Referring to FIG. 8, the parameter receiving unit 251 receives a parameter corresponding to each of the branches in each of the layers configuring a neural network to be trained from the server apparatus 300 (step S101).

The learning unit 252 performs machine learning using training data included by the training data information 241 on a model having the parameter received by the parameter receiving unit 251, and thereby updates a parameter of each of the branches, a weight for each of the branches, and the like. For example, the learning unit 252 updates a weight α in a state where a parameter of each of the branches is fixed (step S102). Moreover, the learning unit 252 updates the parameter of each of the branches by using the updated weight α in a state where the weight α is fixed, and thereby calculates a new local model parameter (step S103). Meanwhile, the learning unit 252 may update the weight and the parameter simultaneously.

The transmitting unit 253 transmits a local model parameter, which is the parameter updated by the learning unit 252, and the weight for each branch to the server apparatus 300 (step S104).

The above is an example of the operation of the client apparatus 200. Subsequently, with reference to FIG. 9, an example of operation of the server apparatus 300 will be described.

FIG. 9 is a flowchart showing an example of operation of the server apparatus 300. Referring to FIG. 9, the receiving unit 351 receives the local model parameter of each of the branches and the weight corresponding to each of the branches from each of the client apparatuses 200 (step S201).

The calculating unit 352 calculates and updates the parameter of the global model for each branch, for each of the layers configuring the neural network, by using the local model parameters and the weights received by the receiving unit 351 (step S202). For example, the calculating unit 352 performs weighting with the weights and takes the average of the local model parameters, and thereby calculates the parameter of the global model. The calculating unit 352 may calculate the parameter of the global model by using the local model parameters, the weights, the number of training data owned by the client apparatuses 200, and the like.

The parameter transmitting unit 352 transmits the parameter of the global model calculated by the calculating unit 352 to the client apparatuses 200 (step S203).

The above is an example of the operation of the server apparatus 300. In the learning system 100, a series of steps as illustrated with reference to FIGS. 8 and 9 are repeated, for example, until a predetermined end condition is satisfied. Any end condition may be determined, for example, the series of steps are repeated a predetermined number of times.

Thus, the server apparatus 300 has the receiving unit 351, the calculating unit 352, and the parameter transmitting unit 353. With such a configuration, the calculating unit 352 can calculate and update the parameter of the global model by using the local model parameters and the weights received by the receiving unit 351. The parameter transmitting unit 353 can transmit the parameter calculated by the calculating unit 352 to the client apparatuses 200. As a result, each of the client apparatuses 200 can update the local model parameter and the weight by using the parameter received from the server apparatus 300. Consequently, without sharing the local model between the client apparatuses 200, each of the client apparatuses 200 can learn the weight and thereby train the local model appropriate for its own data. As a result, it is possible to reduce the risk of information leakage.

Furthermore, in the case of the server apparatus 300 described in this example embodiment, the calculating unit 352 can calculate and update the parameter of the global model by using the local model parameters and the weights received by the receiving unit 351. As a result, it is possible to perform weighting that contributes to update of the global model, in accordance with a weight for each branch of each client apparatus 200, and it is possible to consider a contribution ratio in each client apparatus at the time of update of the global model. Consequently, it is possible to make the learning stable and also possible to increase the accuracy as compared with the case of calculating the parameter of the global model without a weight. Also, it becomes possible to shorten a learning time.

For example, FIG. 10 shows an example of test accuracy with and without a weight in updating the global model. In FIG. 10, the x-axis indicates the number of learning steps, and the y-axis indicates test accuracy. The dotted line indicates the case of using no weight in updating the global model, and the solid line indicates the case of using a weight in updating the global model. Referring to FIG. 10, it can be seen that use of a weight in update of the global model can increase the learning accuracy and shorten the learning time. In the method of using no weight in updating the global model, it is possible to calculate the parameter of the global model, for example, by solving an equation as shown in Equation 2,

$${W}_{i , j} = \frac{1}{n} {\sum }_{k = 1}^{K} {n}_{k} {W}_{i , j}^{( k )} \qquad [ Equation 2 ]$$

$$n = {\sum }_{K}^{K} {n}_{k}$$

where, as in Equation 1, n denotes the number of data owned by the corresponding client apparatus 200, k denotes an identifier for identifying the client apparatus 200, K denotes the number of the client apparatuses 200 included by the learning system 100, and W_{i,j} denotes the parameter of a j^{th} branch of an i^{th} layer.

Further, the client apparatus 200 has the learning unit 252 and the transmitting unit 253. With such a configuration, the transmitting unit 253 can transmit the local model parameter, which is the parameter updated by the learning unit 252, and a weight for each of the branches to the server apparatus 300. As a result, the server apparatus 300 can perform update of the global model using the weight.

Further, the client apparatus 200 can be configured to update the weight in a state where the parameter is fixed, and thereafter update the parameter in a state where the weight is fixed. By thus determining the optimum weight and then updating the parameter, it is possible to appropriately evaluate the degree of update of the parameter in each of the client apparatuses 200.

### Second Example Embodiment

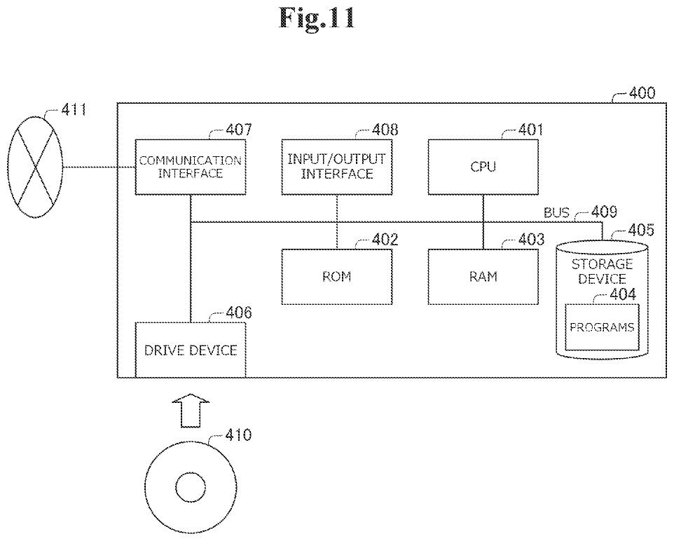

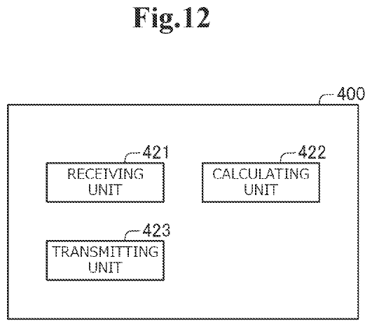

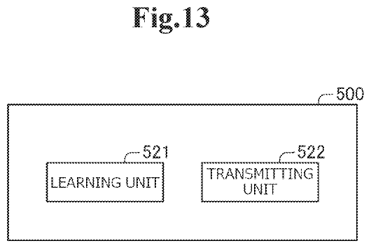

Next, a second example embodiment of the present disclosure will be described with reference to FIGS. 11 to 13. FIG. 11 is a view showing an example of a hardware configuration of a server apparatus 400. FIG. 12 is a block diagram showing an example of a configuration of the server apparatus 400. FIG. 13 is a block diagram showing an example of a configuration of a client apparatus 500.

In the second example embodiment of the present disclosure, an example of the configuration of the server apparatus 400 that performs learning in cooperation with the client apparatus 500 and an example of the configuration of the client apparatus 500 will be described. FIG. 11 shows an example of a hardware configuration of the server apparatus 400. Referring to FIG. 11, as an example, the server apparatus 400 has the following hardware configuration including;
a CPU (Central Processing Unit) 401 (arithmetic logic unit),
a ROM (Read Only Memory) 402 (memory unit),
a RAM (Random Access Memory) 403 (memory unit),
programs 404 loaded to the RAM 403,
a storage device 405 for storing the programs 404,
a drive device 406 that reads from and writes into a recording medium 410 outside an information processing apparatus,
a communication interface 407 connected to a communication network 411 outside the information processing apparatus,
an input/output interface 408 that inputs and outputs data, and
a bus 409 that connects the respective components.

The server apparatus 400 may use, instead of the abovementioned CPU, a GPU (Graphic Processing Unit), a DSP (Digital Signal Processor), a MPU (Micro Processing Unit), a FPU

(Floating point number Processing Unit), a PPU (Physics Processing Unit), a TPU (Tensor Processing Unit), a quantum processor, a microcontroller, or a combination thereof.

Further, the server apparatus 400 can realize functions as a receiving unit 421, a calculating unit 422 and a transmitting unit 423 shown in FIG. 12 by acquisition and execution of the programs 404 by the CPU 401. For example, the programs 404 are stored in the storage device 405 and the ROM 402 in advance, and are loaded to the RAM 403 and executed by the CPU 401 as necessary. Moreover, the programs 404 may be supplied to the CPU 401 via the communication network 411, or may be stored in the recording medium 410 in advance and retrieved and supplied to the CPU 401 by the drive device 406.

FIG. 11 shows an example of a hardware configuration of the server apparatus 400. The hardware configuration of the server apparatus 400 is not limited to the above case. For example, the server apparatus 400 may include part of the abovementioned configuration, for example, without the drive device 406.

The receiving unit 421 receives, from a plurality of client apparatuses 500 that perform federated learning of a neural network having multiplex branches capable of performing different operations on a common input, a local model parameter of each of the multiplex branches and a weight for each branch used in superposing outputs from the respective multiplex branches.

The calculating unit 422 calculates a parameter of a global model based on the local model parameter and the weight received by the receiving unit 421.

The transmitting unit 423 transmits the parameter calculated by the calculating unit 422 to the client apparatus 500.

Thus, the server apparatus 400 has the receiving unit 421, the calculating unit 422, and the transmitting unit 423. With such a configuration, the calculating unit 422 can calculate the parameter of the global model based on the local model parameter and the like received by the receiving unit 421. Moreover, the transmitting unit 423 can transmit the parameter calculated by the calculating unit 422 to the client apparatus 500. As a result, the client apparatus 500 can update the local model parameter and the weight using the received parameter, for example. Consequently, without sharing the local model among the client apparatuses 500, each of the client apparatuses 500 can learn a local model appropriate for its own data by learning a weight for each of the client apparatuses 500, for example. As a result, the risk of information leakage can be reduced.

Furthermore, the server apparatus 400 described in this example embodiment calculates the parameter of the global model based on the local model parameters and the weights. As a result, it is possible to perform weighting that contributes to the update of the global model in accordance with the weight for each of the branches of each of the client apparatuses 200, and it is possible to consider a contribution ratio in each of the client apparatuses when updating the global model. Consequently, it is possible to make learning more stable as compared with the case of using no weight, and it is possible to increase the accuracy.

The server apparatus 400 described above can be realized by installation of a predetermined program in an information processing apparatus such as the server apparatus 400. Specifically, a program as another aspect of the present invention is a computer program for causing an information processing apparatus such as the server apparatus 400 to realize processes to: receive, from a plurality of client apparatuses that perform federated learning of a neural network having multiplex branches capable of performing different operations on a common input, a local model parameter of each of the multiplex branches and a weight for each of the branches used in superposing outputs from the respective multiplex branches; calculate a parameter of a global model based on the received local model parameter and weight; and transmit the calculated parameter to the client apparatus.

Further, a calculation method executed by an information processing apparatus such as the server apparatus 400 described above is a method by an information processing apparatus such as the server apparatus 400 of: receiving, from a plurality of client apparatuses that perform federated learning of a neural network having multiplex branches capable of performing different operations on a common input, a local model parameter of each of the multiplex branches and a weight for each of the branches used in superposing outputs from the respective multiplex branches; calculating a parameter of a global model based on the received local model parameter and weight; and transmitting the calculated parameter to the client apparatus.

The inventions of a program, a computer-readable recording medium having a program recorded thereon and a calculation method with the abovementioned configurations also have the same actions and effects as the server apparatus 400 described above, and therefore, can achieve the abovementioned object of the present invention.

Further, the client apparatus 500 that transmits a local model parameter and the like to the server apparatus 400 can realize functions as a learning unit 521 and a transmitting unit 522 shown in FIG. 13 by acquisition and execution of the programs by the CPU and the like. The hardware configuration of the client apparatus 500 may be the same as the configuration of the server apparatus 400 described with reference to FIG. 11.

The learning unit 521 learns, using training data thereof, a local model parameter of each branch included by a neural network having multiplex branches capable of performing different operations on a common input and a weight for each branch used in superposing outputs from the respective multiplex branches.

The transmitting unit 522 transmits the local model parameter and the weight learned by the learning unit 521 to a server apparatus that generates a global model based on local model parameters.

Thus, the client apparatus 500 has the learning unit 521 and the transmitting unit 522. With such a configuration, the transmitting unit 522 can transmit the local model parameter and the weight learned by the learning unit 521 to the server apparatus 400. As a result, the server apparatus 400 can calculate the parameter of the global model using the weight. Consequently, it is possible to increase the accuracy.

The client apparatus 500 described above can be realized by installation of a predetermined program in an information processing apparatus such as the client apparatus 500. Specifically, a program as another aspect of the present invention is a computer program for causing an information processing apparatus such as the client apparatus 500 to realize processes to: learn, by using training data included by the client apparatus, a local model parameter of each branch included by a neural network having multiplex branches capable of performing different operations on a common input and a weight for each branch used in superposing outputs from the respective multiplex branches; and transmit the learned local model parameter and weight to a server apparatus that generates a global model based on the local model parameter.

Further, a learning method executed by an information processing apparatus such as the client apparatus 500 described above is a method by an information processing apparatus such as the client apparatus 500 of: learning, by using training data included by the client apparatus, a local model parameter of each branch included by a neural network having multiplex branches capable of performing different operations on a common input and a weight for each branch used in superposing outputs from the respective multiplex branches; and transmitting the learned local model parameter and weight to a server apparatus that generates a global model based on the local model parameter.

The inventions of a program, a computer-readable recording medium having a program recorded thereon and a learning method with the abovementioned configurations also have the same actions and effects as the client apparatus 500 described above, and therefore, can achieve the abovementioned object of the present invention.

### <Supplementary Notes>

The whole or part of the example embodiments disclosed above can be described as the following supplementary notes. Below, the overview of a server apparatus and the like according to the present invention. However, the prevent invention is not limited to the following configurations.

### (Supplementary Note 1)

A server apparatus comprising:
a receiving unit configured to receive, from each of a plurality of client apparatuses performing federated learning of a neural network model having multiplex branches capable of performing different operations on a common input, a local model parameter of each of the multiplex branches and a weight for each branch used in superposing outputs from the respective multiplex branches;
a calculating unit configured to calculate a parameter of a global model based on the local model parameter and the weight received by the receiving unit; and
a transmitting unit configured to transmit the parameter calculated by the calculating unit to the client apparatuses.

### (Supplementary Note 2)

The server apparatus according to Supplementary Note 1, wherein
the calculating unit is configured to calculate the parameter of the global model based on a previously stored number of data owned by the client apparatus, the local model parameter, and the weight.

### (Supplementary Note 3)

The server apparatus according to Supplementary Note 2, wherein
the calculating unit is configured to calculate the parameter of the global model by averaging the local model parameters after weighting with the weights.

### (Supplementary Note 4)

The server apparatus according to Supplementary Note 2, wherein
the calculating unit is configured to calculate the parameter of the global model based on the number of data, the local model parameter, and the weight by solving an equation shown by Equation 3:

$${W}_{i , j} = \frac{1}{{A}_{j}} {\sum }_{k = 1}^{K} {n}_{k} {α}_{j}^{( k )} {W}_{i , j}^{( k )} \qquad [ Equation 3 ]$$

$${A}_{j} = {\sum }_{k = 1}^{K} {n}_{k} {α}_{j}^{( k )}$$

where n indicates the number of data, k indicates the client, W_{i,j} indicates the parameter of a j^{th} branch of an i^{th} layer, and a indicates the weight.

### (Supplementary Note 5)

The server apparatus according to Supplementary Note 1, wherein
the weight is a value learned by each of the client apparatuses based on training data owned by the client apparatus.

### (Supplementary Note 6)

A calculation method by an information processing apparatus, the calculation method comprising:
receiving, from each of a plurality of client apparatuses performing federated learning of a neural network model having multiplex branches capable of performing different operations on a common input, a local model parameter of each of the multiplex branches and a weight for each branch used in superposing outputs from the respective multiplex branches;
calculating a parameter of a global model based on the received local model parameter and weight; and
transmitting the calculated parameter to the client apparatuses.

### (Supplementary Note 7)

A computer program comprising instructions for causing an information processing apparatus to realize processes to:
receive, from each of a plurality of client apparatuses performing federated learning of a neural network model having multiplex branches capable of performing different operations on a common input, a local model parameter of each of the multiplex branches and a weight for each branch used in superposing outputs from the respective multiplex branches;
calculate a parameter of a global model based on the received local model parameter and weight; and
transmit the calculated parameter to the client apparatuses.

### (Supplementary Note 8)

A client apparatus comprising:
a learning unit configured to learn, using training data owned by the client apparatus, a local model parameter of each of multiplex branches included by a neural network model having the multiplex branches capable of performing different operations on a common input and a weight for each branch used in superposing outputs from the respective multiplex branches; and
a transmitting unit configured to transmit the local model parameter and the weight learned by the learning unit to a server apparatus that generates a global model based on the local model parameter.

### (Supplementary Note 9)

The client apparatus according to Supplementary Note 8, comprising
a receiving unit configured to receive a parameter of the global model from the server apparatus,
wherein the learning unit is configured to learn the weight in a state where the parameter of the global model is fixed and thereafter learn the local model parameter in a state where the weight is fixed.

### (Supplementary Note 10)

A learning method by an information processing apparatus, the learning method comprising:
learning, using training data owned by the client apparatus, a local model parameter of each of multiplex branches included by a neural network model having the multiplex branches capable of performing different operations on a common input and a weight for each branch used in superposing outputs from the respective multiplex branches; and
transmitting the local model parameter and the weight learned by the learning unit to a server apparatus that generates a global model based on the local model parameter.

Although the present invention has been described above with reference to the example embodiments, the present invention is not limited to the abovementioned example embodiments. The configurations and details of the present invention can be changed in various manners that can be understood by one skilled in the art within the scope of the present invention

### DESCRIPTION OF REFERENCE NUMERALS

100 learning system

200 client apparatus

210 operation input unit

220 screen display unit

230 communication I/F unit

240 storing unit

241 training data information

242 local model information

243 program

250 operation processing unit

251 parameter receiving unit

252 learning unit

253 transmitting unit

300 server apparatus

310 operation input unit

320 screen display unit

330 communication I/F unit

340 storing unit

341 reception information

342 global model information

343 program

350 operation processing unit

351 receiving unit

352 calculating unit

353 parameter transmitting unit

400 server apparatus

401 CPU

402 ROM

403 RAM

404 programs

405 storage device

406 drive device

407 communication interface

408 input/output interface

409 bus

410 recording medium

411 communication network

421 receiving unit

422 calculating unit

423 transmitting unit

500 client apparatus

521 learning unit

522 transmitting unit

1. A server apparatus comprising:
at least one memory configured to store instructions; and
at least one processor configured to execute the instructions to:
receive, from each of a plurality of client apparatuses performing federated learning of a neural network model having multiplex branches capable of performing different operations on a common input, a local model parameter of each of the multiplex branches and a weight for each branch used in superposing outputs from the respective multiplex branches;
calculate a parameter of a global model based on the local model parameter and the weight received by the receiving unit; and
transmit the parameter calculated by the calculating unit to the client apparatuses.

2. The server apparatus according to claim 1, wherein the processor is configured to execute the instructions to
calculate the parameter of the global model based on a previously stored number of data owned by the client apparatus, the local model parameter, and the weight.

3. The server apparatus according to claim 2, wherein the processor is configured to execute the instructions to
calculate the parameter of the global model by averaging the local model parameters after weighting with the weights.

4. The server apparatus according to claim 2, wherein the processor is configured to execute the instructions to
calculate the parameter of the global model based on the number of data, the local model parameter, and the weight by solving an equation shown by Equation 1:
$${W}_{i , j} = \frac{1}{{A}_{j}} {\sum }_{k = 1}^{K} {n}_{k} {α}_{j}^{( k )} {W}_{i , j}^{( k )} \qquad [ Equation 1 ]$$
$${A}_{j} = {\sum }_{k = 1}^{K} {n}_{k} {α}_{j}^{( k )}$$
where n indicates the number of data, k indicates the client, W_{i,j} indicates the parameter of a j^{th} branch of an i^{th} layer, and a indicates the weight.

5. The server apparatus according to claim 1, wherein
the weight is a value learned by each of the client apparatuses based on training data owned by the client apparatus.

6. A calculation method by an information processing apparatus, the calculation method comprising:
receiving, from each of a plurality of client apparatuses performing federated learning of a neural network model having multiplex branches capable of performing different operations on a common input, a local model parameter of each of the multiplex branches and a weight for each branch used in superposing outputs from the respective multiplex branches;
calculating a parameter of a global model based on the received local model parameter and weight; and
transmitting the calculated parameter to the client apparatuses.

7. A client apparatus comprising:
at least one memory configured to store instructions; and
at least one processor configured to execute the instructions to:
learn, using training data owned by the client apparatus, a local model parameter of each of multiplex branches included by a neural network model having the multiplex branches capable of performing different operations on a common input and a weight for each branch used in superposing outputs from the respective multiplex branches; and
transmit the local model parameter and the weight learned by the learning unit to a server apparatus that generates a global model based on the local model parameter.

8. The client apparatus according to claim 7, wherein the processor is configured to execute the instructions to:
receive a parameter of the global model from the server apparatus; and
learn the weight in a state where the parameter of the global model is fixed and thereafter learn the local model parameter in a state where the weight is fixed.
